(19) United States
(12) Patent Application Publication
(10) Pub. No.: US 2025/0333330 A1
(43) Pub. Date: Oct. 30, 2025

(54) FOLDED PAPER WATER FILTER

(71) Applicant: Koslow Technologies Corporation, Waterbury, CT (US)

(72) Inventors: Esad Musovic, Milford, CT (US); Evan E. Koslow, Waterbury, CT (US)

(21) Appl. No.: 19/184,234

(22) Filed: Apr. 21, 2025

Related U.S. Application Data
(60) Provisional application No. 63/639,365, filed on Apr. 26, 2024.

(51) Int. Cl. C02F 1/28; C02F 1/00; C02F 103/42

(52) U.S. Cl. CPC C02F 1/28; C02F 1/001; C02F 2103/42; C02F 2201/006

(57) ABSTRACT

A conical folded-paper cartridge filter that is formed with one closed end and that has an end cap at the open end. The filter medium of the cartridge is pleated so that the open end can be collapsed to fit into the end cap, while retaining a central open space. The end cap may have a tube that protrudes inwardly into the central open space of the cartridge. The tube may support the structure of the cartridge. The tube also may assure that water flows from inside to outside of the pleated paper. Alternatively, the tube may assure that water flows from outside to inside of the pleated paper.

### TECHNICAL FIELD

The present disclosure relates to water filtration. More particularly, the disclosed technology relates to paper water filters.

### BACKGROUND

It is generally known that water can be filtered through paper. Drip coffee filters are a simple example of a paper water filter. Cartridge filters, which have a plain or pleated cylinder of paper captured between two end caps, also are known. For example, swimming pool and hot tub circulation systems frequently make use of cartridge filters.

### SUMMARY

Aspects of the disclosed technology improve upon previous paper filters in numerous ways.

An aspect of the disclosure is a conical paper cartridge filter that is formed with one closed end and that has an end cap at the open end. The paper of the cartridge is pleated so that the open end can be collapsed to fit into the end cap, while retaining a central open space. The end cap may have a tube that protrudes inwardly into the central open space of the cartridge. The tube may support the structure of the cartridge. The tube also may assure that water flows from inside to outside of the pleated paper. Alternatively, the tube may assure that water flows from outside to inside of the pleated paper.

Advantageously, manufacturing a cartridge filter with only one end cap reduces the number of steps and components that are required to form the filter.

An aspect of the disclosure is a paper cartridge filter that is formed with multiple layers of paper, e.g., a first layer that filters particulate metals and a second layer that filters toxic organic chemicals; or a first layer that traps dirt and a second layer that filters microbiological contaminants; or, generally, a first layer that serves a first purpose and one or more subsequent layer(s) that serve one or more other purpose(s). According to some embodiments of the disclosed technology, forming the paper cartridge filter as a sequence of pleated cones can make it easier to arrange or stack the multiple layers of paper within or upon each other.

Advantageously, manufacturing a filter with multiple layers of different paper serving different purposes renders a filter that is more performant than conventional single-layer filters. At the same time, using different layers for different purposes makes it possible to manufacture each layer more easily than would be possible for a single layer that served many purposes.

An aspect of the disclosure is a tool for pleating a sheet of paper to form a conical paper cartridge, the open end of which can be collapsed to define a central open space. The tool includes a mold that defines a conical indentation with teeth and grooves. The tool also includes a conical die that has teeth and grooves, which are shaped to mate into the mold with the sheet of paper trapped and pleated between the mold and die. The mold and die include central flats or central domes by which the sheet of paper is not pleated, thus producing a conical paper cartridge that can be collapsed to define a central open space. In some embodiments, the central flat or dome of the mold is a movable piece that can be actuated to eject the paper cartridge from the mold.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

The present teachings are described more fully hereafter with reference to the accompanying drawings, which depict example embodiments. The following description illustrates the present teachings by way of example, not by way of limitation of the principles of the present teachings.

In this regard:

FIG. 1A and FIG. 1B depict side and bottom views of a conical paper cartridge filter 100, according to an aspect of the disclosure.

FIG. 2A and FIG. 2B depict side and bottom views of a conical paper cartridge filter 200, according to an aspect of the disclosure

FIG. 3A and FIG. 3B depict a mold and die of a tool for forming a folded paper water filter, according to an aspect of the disclosure.

FIG. 4 depicts an end cap 400 for use in a folded paper water filter cartridge, according to an aspect of the disclosure.

FIG. 5 depicts a cutaway view of a paper filter cartridge 500 that includes the folded paper water filter 100 assembled into the end cap 400.

Throughout the drawings, corresponding reference numerals indicate like or corresponding parts and features.

### DETAILED DESCRIPTION

For purposes of explanation and not limitation, specific details are set forth such as particular structures, architectures, interfaces, techniques, etc. in order to provide a thorough understanding. In other instances, detailed descriptions of well-known devices and/or methods are omitted so as not to obscure the description with unnecessary detail.

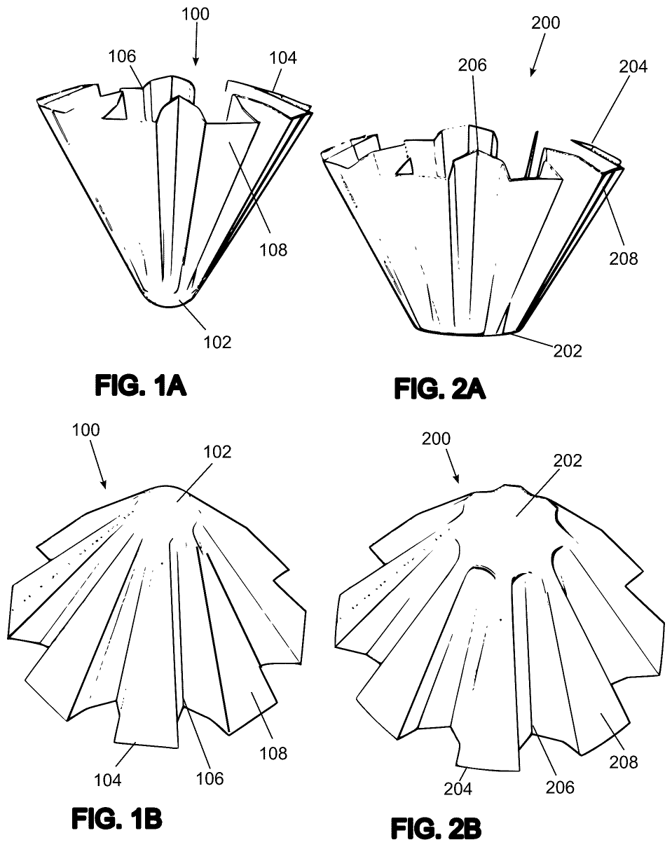

FIG. 1A and FIG. 1B depict side and bottom views of a conical paper cartridge filter 100, according to an aspect of the disclosure.

The filter 100 has a domed or rounded closed end 102 and a periphery 104. Between the closed end 102 and the periphery 104, the paper of the filter 100 is pleated with inward creases 106 and outward flats 108. The complementary arrangement of creases 106 and flats 108, as shown in FIG. 1A and FIG. 1B, makes it possible to squeeze together the periphery 104 and produce a conical cartridge with an outer surface formed by the flats 108 and an inner surface formed by the creases 106. Because the closed end 102 is a domed or rounded shape, rather than a point, when the periphery 104 is squeezed together the inner surface of the cartridge defines a hollow interior space.

FIG. 2A and FIG. 2B depict side and bottom views of a conical paper cartridge filter 200, according to an aspect of the disclosure.

The filter 200 has a flat closed end 202 and a periphery 204. Between the closed end 202 and the periphery 204, the paper of the filter 200 is pleated with inward creases 206 and outward flats 208. The complementary arrangement of creases 206 and flats 208, as shown in FIG. 2A and FIG. 2B, makes it possible to squeeze together the periphery 204 and produce a conical cartridge with an outer surface formed by the flats 208 and an inner surface formed by the creases 206. Because the closed end 202 is a flat shape, rather than a point, when the periphery 204 is squeezed together the inner surface of the cartridge defines a hollow interior space.

An ordinary skilled worker will appreciate that multiple filters 100 or 200 may be made from different types of paper, i.e. in multiple layers of different capabilities, and that multiple layers may be stacked together and squeezed to form a conical cartridge with a closed end, a hollow interior space, and filtration capabilities of all the layers in combination.

For example, a first layer of paper may be provided with a first type of adsorbent particulates (e.g., activated carbon particulates for chemically trapping toxic organic chemicals) held by nanofibers on the order of 200-2,000 micron in length and 40-1,000 nm in diameter, while a second layer of paper may be provided with trace metal and toxic elemental adsorbent particlesheld by nanofibers on the order of 200-2,000 micron in length and 40-1,000 nm in diameter.

Different layers of paper may be engineered to capture any one or more of the following: nano-size lead orthophosphate particles, PFAS chemicals, chlorine, chloramine, sulfides, mercury, and lead at both high-pH and low-pH, toxic organic chemicals (VOCs, TTHMs, herbicides, pesticides, pharmaceuticals and industrial chemicals), or microbiological contaminants such as viruses, bacteria, and oocysts.

Additionally, multiple layers of paper of differing pore size and/or mean free path (MFP), as determined by capillary porometry, may be layered together for various effects. For example, layers can be combined to produce a filter that has enhanced dirt-holding capacity from a first layer with larger pore size while also having enhanced contaminant removal from a second layer with smaller MFP. Typically, the first layer would be on the upstream side of the filter while the second layer would be toward the downstream side of the filter. For example, a first layer with pore size on the order of 2-10 micron could be used in combination with a second layer with MFP on the order of 0.5-2 micron.

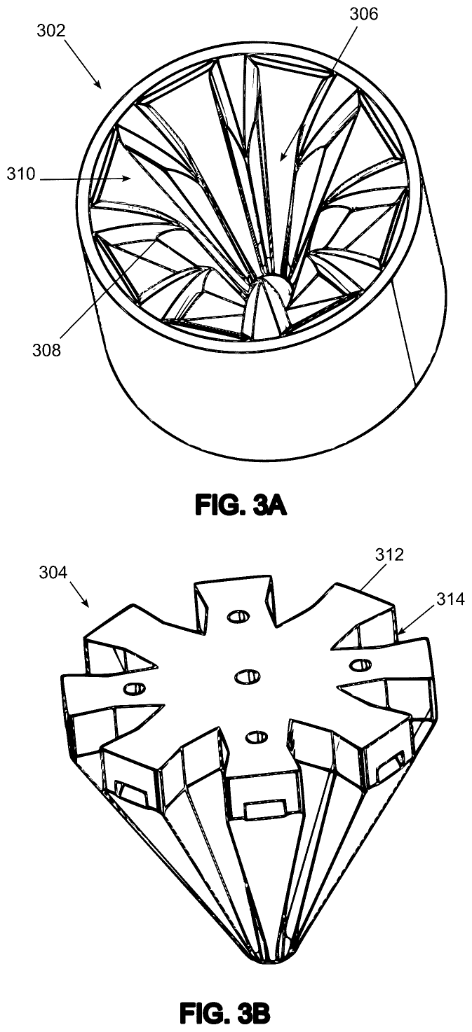

FIG. 3A and FIG. 3B depict a mold 302 and die 304 of a tool for forming a folded paper water filter, according to an aspect of the disclosure.

The tool includes the mold 302 that defines a conical indentation 306 with teeth 308 and grooves 310. The tool also includes the conical die 304 that has teeth 312 and grooves 314, which are shaped to mate into the mold with the sheet of paper trapped and pleated between the mold and die. The teeth 308 of the mold 302 form the creases 106 or 206, whereas the grooves 310 of the mold 302 form the flats 108 or 208. The mold and die include central flats 316, 318 respectively, by which the sheet of paper is not pleated, thus producing a conical paper cartridge that can be collapsed to define a central open space. In some embodiments, the central flat or dome of the mold 302 is a movable piece that can be actuated to eject the paper cartridge from the mold.

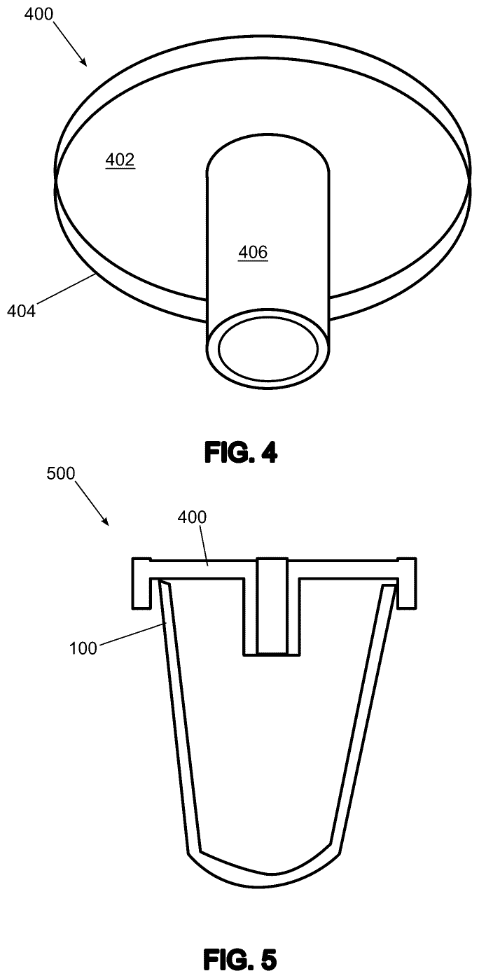

FIG. 4 depicts an end cap 400 for use in a folded paper water filter cartridge, according to an aspect of the disclosure. The end cap 400 includes a flat surface 402 that is surrounded by a rim 404, which together receive and engage the open end of a paper filter cartridge that is formed from the paper filter 100 or 200 by squeezing together the periphery 104 or 204. The end cap 400 also may include a tube 406 for guiding water into or out of the hollow interior space of the paper filter cartridge.

The most common means to apply a plastic end cap to the filter open end is either through the use of hot melt or fusion welding. When using hot melt, the end cap is so designed to receive a liquid hot melt on its inner surface and the filter is pressed into a circular bead of this liquid hot melt.

In some cases, the hot melt can be replaced through the use of plastisol, urethane, polymer foams and other materials. In some cases, such as when using plastisol, there is no plastic end cap, and the plastisol is directly molded into the desired final shape of the end cap. Another method can be fusion welding where the surface of the end cap is exposed to heat, often through the application of infrared radiation applied to a specific region of the end cap, to cause a portion of the end cap surface to soften and/or melt. The filter can then be pressed directly into this molten surface to form the required seal. There are other means to apply a closure to the open end of the filter and such enclosure can provide a variety of precision sealing surfaces ranging from O-ring, elastomeric seals, and plastic reflex seals. All of these methods can be applied to the current disclosure.

FIG. 5 depicts a cutaway view of a paper filter cartridge 500 that includes the folded paper water filter 100 assembled into the end cap 400.

According to embodiments of the disclosure, a gravity-flow water carafe or dispenser may include a lower water chamber; a fill reservoir mounted on or into the top of the lower water chamber, wherein the fill reservoir includes a filter holder that extends down from the fill reservoir into the lower water chamber; and a filter cartridge as previously described, mounted into the filter holder so that water passes from the fill reservoir through the pleated cone to the lower water chamber.

According to embodiments of the disclosure, a refrigerator or chilled-water dispenser may include a cooling coil; a first water line in proximity to the cooling coil; a filter holder connected with the first water line; a second water line connected between the filter holder and a spout; and a filter cartridge as previously described, mounted into the filter holder so that water passes from the first water line through the pleated cone to the second water line.

According to embodiments of the disclosure, a water dispenser may include a faucet; a receptacle below the faucet; a filter holder mounted at the end of the faucet; and a filter cartridge as previously described, mounted into the filter holder so that water passes from the faucet through the pleated cone into a receptacle.

The present teachings have been described in language more or less specific as to structural, mechanical, and functional features. It is to be understood, however, that the present teachings are not limited to the specific features shown and described, since the apparatus, system, and/or method herein disclosed comprises preferred forms of putting the present teachings into effect.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The use of “first”, “second,” etc., for different features/components of the present disclosure are only intended to distinguish the features/components from other similar features/components and not to impart any order or hierarchy to the features/components, unless explicitly stated otherwise. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C.

Unless explicitly stated otherwise, the disclosure and claims should be understood to encompass not only the precise value, material, or property that is explicitly described, but also values, materials, or properties that are sufficiently similar so as to accomplish the same result in the same way as what is explicitly described.

Other than in the operating examples, or where otherwise indicated, all numbers expressing quantities of ingredients or reaction conditions used herein are to be understood as modified in all instances by the term “about”.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification and the attached drawings.

What is claimed is:

1. A filter cartridge comprising:
at least one layer of paper that is folded into a pleated cone that has an inner cavity at the open end and that has a domed or flat closed end, wherein the pleats of the cone include flat sections at an outer surface of the cone and creases at the surface of the inner cavity; and
a disc-shaped end cap that has a flat inner surface attached to the periphery of the pleated cone, wherein the end cap has a central hole that is aligned in registry with the inner cavity of the pleated cone.

2. The filter cartridge of claim 1, wherein the end cap is glued to the periphery of the pleated cone.

3. The filter cartridge of claim 1, wherein the at least one layer of paper comprises a first layer that has a first porosity and a second layer that has different porosity than the first layer.

4. The filter cartridge of claim 1, wherein the at least one layer of paper comprises a first layer that has a first mean free path (MFP) and a second layer that has a second MFP, which is different from the first MFP.

5. The filter cartridge of claim 1, wherein the at least one layer of paper comprises a first layer that contains a first reagent, which is adapted to adsorb a first type of water contaminant, and the at least one layer of paper comprises a second layer that contains a second reagent, which is adapted to adsorb a second type of water contaminant.

6. The filter cartridge of claim 1, wherein the at least one layer of paper comprises nanofibers and active ingredients that are trapped among the nanofibers.

7. The filter cartridge of claim 6, wherein the active ingredients may include at least one of fine particulate ingredients, activated carbon, materials used to provide toxic metals adsorption, alumina-silicates, titanium silicates, hydroxyapatites, titanium oxides and hydroxides, zeolites, smectite clays, iron oxides, aluminas, ion-exchange resins, chemical treatments to provide enhanced nano-particulate interception, positively charge polymers and coatings, and lower molecular weight amines and silicon-amine coatings.

8. The filter cartridge of claim 1, wherein the end cap comprises a tube that protrudes from the hole into the inner cavity of the pleated cone.

9. The filter cartridge of claim 1, wherein the at least one layer of paper is at least 0.5 mm thick.

10. The filter cartridge of claim 1, wherein the at least one layer of paper traps at least one contaminant selected from the group consisting of: nano-size lead orthophosphate particles, PFAS chemicals, chlorine, chloramine, sulfides, mercury, soluble and insoluble lead, and toxic organic chemicals.
